(19) United States
(12) Patent Application Publication
(10) Pub. No.: US 2025/0363436 A1
(43) Pub. Date: Nov. 27, 2025

(54) SYSTEM AND METHOD FOR CROSS MAPPING OF AN EVIDENCE TO FRAMEWORKS

(71) Applicant: Anecdotes.ai, LTD, Tel Aviv (IL)

(72) Inventor: Ethan Raphael ALTMANN, Ramat Gan (IL)

(73) Assignee: Anecdotes.ai, LTD, Tel Aviv (IL)

(21) Appl. No.: 19/216,152

(22) Filed: May 22, 2025

Related U.S. Application Data
(60) Provisional application No. 63/651,072, filed on May 23, 2024.

(51) Int. Cl. G06Q 10/0635

(52) U.S. Cl. CPC G06Q 10/0635

(57) ABSTRACT

A system and method for cross mapping an evidence data for risk management is provided. The method includes identifying a matching requirement for a first data element of the evidence data by matching the first data element to a requirement in a centralized requirement layer of a multi-layer data architecture; mapping the matching requirement to at least one control in more than one framework of a plurality of frameworks according to the multi-layer data architecture, wherein the centralized requirement layer of the multi-layer data architecture has a plurality of requirements that each represent a criterion and are shared across the plurality of frameworks; and determining, based on the mapping, a control state for the at least one control in more than one framework of the plurality of frameworks in response to the evidence data.

### CROSS-REFERENCE TO RELATED APPLICATIONS

This application claims the benefit of U.S. Provisional Application No. 63/651,072 filed on May 23, 2024, the contents of which are hereby incorporated by reference.

### TECHNICAL FIELD

The present disclosure relates generally to security compliance, in particular, to the cross-mapping of evidence artifacts to demonstrate efficient determination and effective control implementation across multiple information security frameworks.

### BACKGROUND

Government, Risk, and Compliance (GRC) strategy is adopted and integrated in many organizations, big and small, in order to achieve organization objectives. Here, compliance indicates the organization's compliance with requirements of internal and/or external guidelines, also referred to as frameworks. Frameworks are widely accepted guidelines or standards that are established by external organizations for individuals, organizations, or the like to adhere to, in order to protect data that are handled and utilized. Common frameworks include, for example, but not limited to, System and organization controls (SOC), Health Insurance Portability and Accountability Act (HIPAA), Payment Card Industry Data Security Standard (PCI DSS), and the like. Stakeholders may leverage such frameworks to gauge compliance and security of the organization. Noncompliance with regulatory or contractual obligations, or industry standards, hereinafter referred to as “frameworks” can lead to adverse effects such as financial penalties, loss of operating licenses, investigations, and more.

Thus, compliance of present and future processes, as well as activities to address such compliance requirements may be key features for maintenance and healthy growth of the organization. Organizations implement compliance programs to reduce risk to the organization. Compliance programs require a clear strategy, and tooling is often implemented in order to ensure this strategy is executed effectively.

It has been identified that evidence may be collected from all parts of the organization to determine compliance. Evidence artifacts (or evidences) are either raw data collected from organizational systems, or documents that may come in the form of policies, procedures, or the like. Evidence is intended to be indicative of effective control implementation, which in turn should indicate compliance and/or conformity to standard regulations.

Currently implemented techniques often rely on manual pulling of evidence, which are limited to isolated auditing and checking off boxes in a list of audit requirements. The technique is manually performed at a specific time of need (e.g., before an audit, at reporting season, and the like). The static nature of this norm does not constitute effective and continuous control monitoring, which, in turn, limits GRC functions to being audit oriented, as opposed to focusing on actively reducing risk within the organization. Furthermore, this norm can lead to inaccuracies with regard to the internal measurement of compliance at a given point in time, as compliance is only validated periodically, at fixed events.

An organization may require an annual audit or attestation to multiple compliance obligations (frameworks). These frameworks often have significant overlap with regard to evidence expectations. However, adherence to the obligations of these frameworks is often monitored and/or audited in silos, with significant duplication of effort. As organizations adopt more and more frameworks as a result of business expansion, these siloed processes lead to excessive overhead.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for cross mapping an evidence data for risk management. The method comprises: identifying a matching requirement for a first data element of the evidence data by matching the first data element to a requirement in a centralized requirement layer of a multi-layer data architecture; mapping the matching requirement to at least one control in more than one framework of a plurality of frameworks according to the multi-layer data architecture, wherein the centralized requirement layer of the multi-layer data architecture has a plurality of requirements that each represent a criterion and are shared across the plurality of frameworks; and determining, based on the mapping, a control state for the at least one control in more than one framework of the plurality of frameworks in response to the evidence data.

Certain embodiments disclosed herein also include a non-transitory computer readable medium having stored thereon causing a processing circuitry to execute a process, the process comprising: identifying a matching requirement for a first data element of the evidence data by matching the first data element to a requirement in a centralized requirement layer of a multi-layer data architecture; mapping the matching requirement to at least one control in more than one framework of a plurality of frameworks according to the multi-layer data architecture, wherein the centralized requirement layer of the multi-layer data architecture has a plurality of requirements that each represent a criterion and are shared across the plurality of frameworks; and determining, based on the mapping, a control state for the at least one control in more than one framework of the plurality of frameworks in response to the evidence data.

Certain embodiments disclosed herein also include a system for cross mapping an evidence data for risk management. The system comprises: a processing circuitry; and a memory, the memory containing instructions that, when executed by the processing circuitry, configure the system to: identify a matching requirement for a first data element of the evidence data by matching the first data element to a requirement in a centralized requirement layer of a multi-layer data architecture; map the matching requirement to at least one control in more than one framework of a plurality of frameworks according to the multi-layer data architecture, wherein the centralized requirement layer of the multi-layer data architecture has a plurality of requirements that each represent a criterion and are shared across the plurality of frameworks; and determine, based on the mapping, a control state for the at least one control in more than one framework of the plurality of frameworks in response to the evidence data.

Certain embodiments disclosed herein include the method, non-transitory computer readable medium, or system noted above, further including or being configured to perform the following steps: constructing a normalized data structure for a raw data of the evidence data, wherein the normalized data structure organizes criteria in the raw data as data elements.

Certain embodiments disclosed herein include the method, non-transitory computer readable medium, or system noted above, wherein the centralized requirement layer has established relationships between the plurality of requirements and a plurality of controls across the plurality of frameworks.

Certain embodiments disclosed herein include the method, non-transitory computer readable medium, or system noted above, wherein the mapping of the matching requirement to at least one control indicates that the first data element defined by the matching requirement fulfills the criterion of the at least one control.

Certain embodiments disclosed herein include the method, non-transitory computer readable medium, or system noted above, further including or being configured to perform the following steps: determining a compliance score for each of the plurality of frameworks, wherein the compliance score represents a degree of overall compliance based on a plurality of controls and their control states for each of the plurality of frameworks.

Certain embodiments disclosed herein include the method, non-transitory computer readable medium, or system noted above, further including or being configured to perform the following steps: generating a notification of compliance with respect to the plurality of frameworks, wherein the notification of compliance indicates a compliance and risk assessments for a tenant; and causing a display of the notification via a tenant device.

Certain embodiments disclosed herein include the method, non-transitory computer readable medium, or system noted above, wherein the notification includes at least one of: a suggestion to mitigate risks, a suggestion to mitigate a violation, a mitigation action, a compliance score, a list of controls, and their control state.

Certain embodiments disclosed herein include the method, non-transitory computer readable medium, or system noted above, wherein the mapping is a cross mapping of the evidence data to the plurality of frameworks in near real-time.

Certain embodiments disclosed herein include the method, non-transitory computer readable medium, or system noted above, wherein the multi-layer data architecture incorporates a new control by measuring a vector distance between a new criterion in the new control to the plurality of requirements in the centralized requirement layer in the multi-layer data architecture.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flow diagram illustrating a mapping of an evidence to a plurality of frameworks via a multi-layer architecture according to an embodiment.

FIG. 3 is a flowchart illustrating a method for cross mapping an evidence according to an embodiment.

FIG. 4 is a flowchart illustrating a method for adding a control to a multi-layer architecture according to an embodiment.

FIG. 5 is a schematic diagram of an evidence system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for cross mapping an evidence to one or more controls in order to efficiently determine alignment and assess risks with respect to compliance frameworks. A centralized requirement layer is employed between an evidence layer and a control layer, in a multi-layer data architecture, to concurrently cross-link the evidence to the one or more controls of the control layer. The control layer may be composed of a large number of controls related to a plurality of frameworks. Each control may comprise one or more criteria that, when met, are indicative of effective control implementation, which, in turn, enable an organization to attest to adherence with a particular framework. The centralized requirement layer that has universal requirements defining the criteria acts as bridge to associate the evidence data to multiple controls across various frameworks accurate and efficiently.

Organizations often employ multiple frameworks each with at least 50 or even in the hundred ranges in the number of controls. To this end, siloes analysis of these controls for the multiple frameworks are inefficient and burdensome for computing resources. Moreover, near real-time or real-time analysis for current risk assessments adds additional loads, making manual analysis highly challenging, virtually impossible.

The embodiments disclosed herein utilize the multi-layer data structure that provides the universal requirements that are commonly shared amongst similar controls across various frameworks. The universal requirement represented as unified terminologies and data forms to map substantially similar criteria of the controls using a common requirement data. To this end, a requirement identified for an evidence is concurrently utilized for compliance analysis against a plurality of frameworks. The centralized requirement layer leverages the significant overlap between the plurality of frameworks, their controls, and criteria for their controls in order to connect the plurality of frameworks using the universal requirements. It should be noted that the centralized requirement layer allows convergence of similar controls to the common universal requirement to minimize redundant, siloed evaluation of the evidence across frameworks. It should be further noted that such convergence and concurrent analysis reduces processing time, power, and memory space to conserve computing resources.

In addition, the embodiments disclosed herein allow rapid determination of compliance for continuous up-to-date risk assessments and management. Due to the amount of evidence data being collected and the unstructured nature of the evidence data, compliance analysis statically performed at certain times or needs (e.g., audit request). However, the concurrent mapping of the evidence to the plurality of frameworks allows continuous tracking of compliance as the evidence data are collected. In an embodiment, the evidence data is dynamically analyzed in real-time or near real-time as the evidence data is received. Moreover, the evidence data is analyzed to determine and update the compliance to the multiple frameworks. It should be appreciated that such dynamic analysis enabled by the disclosed embodiments resolves the problems of static and delayed compliance analyses that can be detrimental to the security or validity of the organization.

The embodiments disclosed herein further enable accurate mapping of the evidence to the controls of various frameworks with added granularity. Some current approach match controls that are sufficiently close across frameworks to facilitate compliance analysis for the plurality of frameworks. However, such matching can be misleading in that close controls are not necessarily identical. According to the disclosed embodiments, the universal requirements define criteria of controls rather than the controls themselves. The requirements provide granularity in the mapping to indicate a portion of the control for controls that have multiple criteria for implementation. Such matching of requirements reduces false positives with added accuracy while still reducing the processing time for matching and compliance analysis.

One of ordinary skill in the art would understand that the embodiments disclosed herein enable accurate and efficient compliance analysis while improving computing efficiency. Moreover, the embodiments disclosed herein provide efficient and continuous risk assessment against the plurality of frameworks in order to reduce risk at the organization. It should be further noted that the compliance scores and related information generated herein may be readily implemented for auditing.

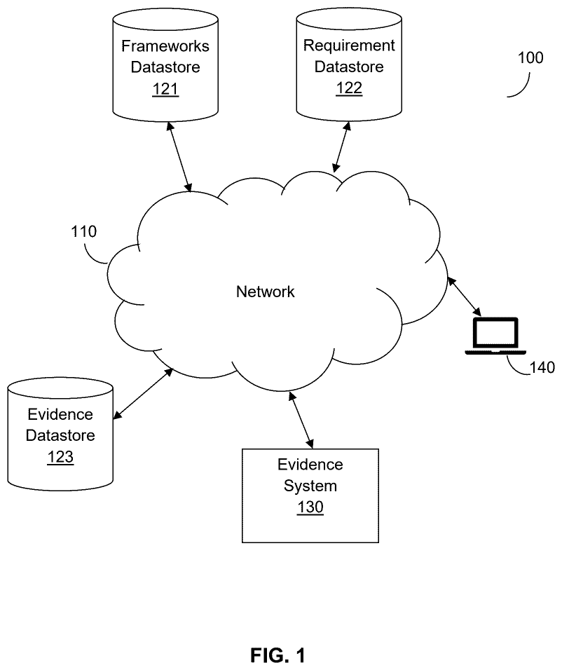

FIG. 1 shows an example network diagram 100 utilized to describe the various disclosed embodiments. In the example network diagram 100, a frameworks datastore 121, a requirement datastore 122, an evidence datastore 123, an evidence system 130, and a user device 140 communicate via a network 110. The network 110 may be, but is not limited to, a wireless, cellular, or wired network, a local area network (LAN), a wide area network (WAN), a metro area network (MAN), the Internet, the worldwide web (WWW), similar networks, and any combination thereof.

In some implementations, the frameworks datastore 121, the requirement datastore 122, the evidence datastore 123, and the evidence system 130 are components of the same cloud computing environment. The cloud computing environment may be a public cloud, a private cloud, or a hybrid cloud. A public cloud is owned and operated by a third-party service provider that delivers computing resources for use over the internet, whereas a private cloud is cloud computing resources that are exclusively used by a single business or an organization. A hybrid cloud combines the public cloud and the private cloud that allows data and application sharing between both types of computing resources. Some examples of a cloud environment may include, and without limitation, Amazon® Web Services (AWS), Microsoft® Azure, Google® Cloud Platform (GCP), and the like, which offer shared infrastructure managed by the cloud providers, providing scalability, flexibility, and reduced infrastructure management.

The frameworks datastore 121 may be a component, a device, a database, a storage, or the like that is configured to store information of a plurality of compliance frameworks (hereinafter simply referred to as “frameworks”) and their controls. Framework data for each of the plurality of frameworks are provided to the evidence system 130, over the network, for simultaneous mapping of an evidence of an entity (i.e., a tenant system) to the plurality of frameworks.

The framework data describes the guidelines of each framework including a plurality of controls that are executed to be compliant with each framework. The framework data may be organized with a framework layer including the framework information and a subordinate control layer including the plurality of controls that are associated with the respective framework. In an embodiment, the framework data may be updated upon receiving updated guidelines and/or controls from the external organizations that establish the framework. For example, when new controls are established for SOC2 for added security, the SOC2 framework data is updated to include the new controls in the control layer. In some implementations, the frameworks datastore may be a relational datastore that uses structured query language (SQL).

A framework is a set of guidelines or standards that are established by external organizations to protect data that are handled and utilized by an entity (e.g., an individual, an organization, or the like). Examples of frameworks include, without limitation, Security and Compliance Standard (SOC), Health Insurance Portability and Accountability Act (HIPAA), Payment Card Industry Data Security Standard (PCI DSS), and the like. As noted above, frameworks are utilized to assess the validity and/or security of the entity, which may relate to data and financial security. Thus, compliance with at least one framework is audited and determined to manifest the entity's validity.

A control of a framework is a process and/or a policy that is performed to comply with the framework guidelines or standards. Some examples of controls include, but are not limited to, organizational controls, access controls, human resources, risk assessment, monitoring, vendor management, information and communication controls, system operation controls, and the like, and any combination thereof. Such controls each have one or more criteria to be satisfied in order for the control to be fulfilled, and therefore checked off as being compliant to the respective framework. Fulfillment of the criteria is shown by at least one evidence that is collected for the entity. An evidence (or an evidence artifact) is a data or document such as, but not limited to, policies, standard operation procedures, audit log samples, authentication configurations, technical system configurations, change management mechanisms, regulatory mandates, training records, and the like, and more that are collected from the tenant system (or infrastructure) to support conformity to the criteria of the control and their framework.

It should be noted that similar controls that have similar descriptions and aims may be present in multiple different frameworks. Such similar controls of different frameworks may have criteria that are common, different, or both. As an example, a first control for a multi-factor authentication in one framework may include two criteria compared to a second control also for the multi-factor authentication in another framework may include the same two criteria as the first control but have one additional criterion to be fulfilled. Although some common criteria may exist between similar controls, one-to-one equivalence matching of such similar controls may be erroneous and result in false security. To this end, a requirement layer including a plurality of requirements is employed to link similar controls that share common criteria.

The requirement datastore 122 may be a component, a device, a database, a storage, or the like that is configured to store information on the plurality of requirements and their relationship with the plurality of controls of various frameworks. A requirement is unified terminology and data that represents one criterion of controls. As a unified terminology, the requirement is universally applied to controls across multiple frameworks. Similar controls that have common criteria are linked via the common requirement. With reference to the above-mentioned example, the first control and the second control, which are similar controls, both for multi-factor authentication but different frameworks, may be linked by the two common requirements, each representing a criterion. In the same example, the second control that has one additional criterion is associated with another requirement that is different from either of the two common requirements.

The requirement datastore 122 organizes the plurality of requirements in a requirement layer and includes a relationship between the plurality of requirements to the plurality of controls of the frameworks. The universal nature of the requirements allows the requirement data to be mapped to controls of any framework without restriction. To this end, the requirement enables the linking of controls of different frameworks and further allows cross mapping of an evidence to multiple controls of different frameworks. In an embodiment, the requirement layer including the plurality of requirements is a library of requirements. In an embodiment, the requirement layer is a data layer that maps an evidence artifact from a tenant system to one or more controls of the control layer to determine the compliance status of a plurality of frameworks effectively and accurately. It should be noted that controls of different frameworks often have significant overlaps and thus, synchronous mapping of evidences to multiple controls across frameworks eliminates repeated computing to map an evidence data to each of the plurality of controls and plurality of frameworks, thereby conserving computing resources. The cross mapping of an evidence using the multiple data layers of the multi-layer data architecture is described further below.

In an embodiment, the requirement datastore 122 may include expected evidences for each requirement data in the requirement layer. The expected evidence is an evidence that may be collected from the tenant system that would indicate requirement fulfillment and thus, compliance with the control and its respective framework. In an embodiment, the requirement may include at least one expected evidence from different plugins (e.g., services, applications, or the like) that are deployed and executed in the tenant system. As an example, a password requirement includes expected evidence of password rules from multiple services that are utilized in the tenant system or infrastructure. In an embodiment, the stored expected evidences for each requirement provides a clear indication of the evidences that should be collected to increase compliance state to one or more frameworks. That is, the expected evidences may be a guide for tenant entities to amend gaps in compliance by complying with the standards of the frameworks.

The frameworks datastore 121 and the requirement datastore 122 are shown as separate components for illustrative purposes. It should be noted that the frameworks datastore 121 and the requirement datastore 122 may be, for example, but not limited to, separate datastores, a single datastore, components of a larger data warehouse, or the like, or any combination thereof without departing from the scope of the disclosed embodiments. In some implementations, frameworks datastore 121 and/or the requirement datastore 122 may be directly connected to the evidence system 130.

The evidence datastore 123 is a component, a device, a database, a storage, or the like that stores evidences of compliance that are collected as raw evidence data from the tenant system or infrastructure. In an embodiment, the raw evidence data are provided to the evidence system 130 and analyzed in order to determine a compliance status (or posture) with respect to the compliance frameworks. The evidence datastore 123 may further store normalized data structures of the collected raw evidences.

The evidences of compliance are data and/or documents that are relevant to framework compliance and include, for example, but are not limited to, policies, standard operation procedures (SOPs), audit trails and logs, training records, incident response plans, change management policies, risk assessment, third-party agreements, plugin configuration, system configuration, and the like, and any combination thereof. The evidences of compliance, raw and/or normalized, may be associated with metadata such as, but not limited to, datetime stamps, application programming interface (API) requests performed, item counts, a one-way hash, tenant name or identifier (ID), instance ID, plugin ID, cloud environment ID, collection time, test result (e.g., success or failure, compliance score, etc.), and the like and stored in the evidence datastore 123.

In an embodiment, designated buckets are generated for each tenant entity to securely and separately store evidence data from multiple tenant entities, plugins, organization departments, and the like, and any combination thereof. The raw evidence data stored in the datastore may be collected through querying of the tenant system (or infrastructure). In another example embodiment, the collection may be initiated according to a predetermined schedule, on demand, or both. The evidence datastore 123 may be deployed at the tenant cloud, the evidence system cloud, a separate third cloud, or a combination thereof.

In an embodiment, the evidence datastore 123 may further include compliance analyses and the status of the tenant entity with respect to the plurality of frameworks. The compliance statuses of the tenant entity are updated as additional evidences are collected, mapped, and analyzed against the plurality of frameworks.

The evidence system 130 is a component, a server, a device, a system, or the like configured to determine the compliance statuses of a plurality of frameworks by employing a universal requirement layer. The evidence system 130 applies a multi-layer data architecture including, but not limited to, the framework layer, the control layer, the requirement layer, and the like to the collected evidences in order to accurately cross map an evidence to multiple controls and their respective compliance frameworks. In an embodiment, the raw evidence data is processed to generate normalized data structures. Data elements that may define criteria of one or more controls are extracted from the raw evidence data and added to the normalized data structure. In an example embodiment, the raw evidence data or normalized data structure may be retrieved from the evidence datastore 123. In another example embodiment, the raw evidence data is collected from the tenant infrastructure or system.

At least one evidence data element of the normalized data structures is identified as a requirement in the library of requirements of the requirement layer. The unified requirement data are applied across controls of the plurality of frameworks to simultaneously determine the compliance statuses (e.g., compliance score, etc.). In an embodiment, the requirement data is cross mapped to one or more controls based on the requirement-control relationship as described and established in the requirement layer of the multi-layer data architecture. In a further embodiment, the mapped evidence satisfies a criterion of one or more controls that may be reflected in the framework compliance status.

It should be noted that a single processing of a collected evidence may update the compliance statuses of multiple frameworks concurrently. It should be appreciated that the cross mapping of an evidence for compliance testing of multiple frameworks is enabled by the unified requirement terminology. Such simultaneous testing significantly reduces processing time, thereby conserving computing resources and power. Repeated processing of an evidence against each of the plurality of frameworks is eliminated.

The user device (UD) 140 may be, but is not limited to, a personal computer, a laptop, a tablet computer, a smartphone, a wearable computing device, or any other device capable of receiving and displaying notifications. In an embodiment, the compliance statuses for the plurality of frameworks are caused to be displayed at a user device 140 associated with the tenant entity. The notification may be, but is not limited to, a human readable summary, a report, an alert, or the like. Such notification may describe, for example, but is not limited to, an overall compliance status (or posture) for at least one framework, a control state for each control, a conformity to each requirement, a list of requirements, a list of evidences (e.g., expected evidence, collected evidence, etc.), and the like, and any combination thereof for the associated tenant entity. It should be noted that such notification is securely displayed to the specific tenant entity without exposure to other tenant entities.

In a further embodiment, the notification and/or compliance information may be caused to be displayed via a graphical user interface (GUI). The operation of the tenant entity may interact with the GUI via the user device 140 to gather compliance statuses, to prepare for auditing, for guidance to meet framework standards, to explore other potential frameworks, and the like, and any combination thereof.

According to the disclosed embodiments, the multi-layer data architecture is a complex, interconnected network that describes the relationship between requirements, controls, and frameworks. The interconnected network captures the nuances of the controls using requirements for added granularity, while keeping the network data concise, by accounting for the considerable amount of overlap between the requirements and controls across the various frameworks. The evidence system 130 employs the data architecture and is configured to perform compliance testing of a tenant against multiple frameworks at sufficiently rapid rate for continuous monitoring of compliance. The compliance status (or posture) of the tenant entity is performed at near real-time at regular time intervals. It should be noted that over 5000 controls may be available for a framework and a tenant entity may adopt at least one, but often hundreds of different compliance frameworks for secure and effective operation. Thus, manual matching or mapping to determine compliance cannot reasonably be performed.

In an embodiment, the evidence system 130 is configured to incorporate new controls and/or frameworks that are received in the established multi-layer data architecture. The new controls and/or frameworks are processed and organized to match existing controls and/or requirements or to generate new entries therefrom. In an embodiment, at least one algorithm such as a machine learning algorithm, an artificial intelligence algorithm, and the like, and any combination thereof may be applied to the received controls and/or framework data to identify matching requirements and to incorporate the controls in the multi-layer architecture. In an embodiment, embeddings of the requirement layer and controls are determined for the comparison based on a vector similarity search. In a further embodiment, the algorithm embeds the requirement layer with all related metadata such as, but not limited to, description, historical data, current requirement-control linkages, and the like, and any combination thereof. It should be noted that the similarity and overlap of controls across frameworks. By employing the granular requirements in the requirement layer, the new controls are readily incorporated into the established multi-layer architecture.

It should be noted that the arrangement of components in FIG. 1 is shown for illustrative purposes. Other configurations or connections of these components may be deployed and do not depart from the scope of the disclosed embodiments described herein.

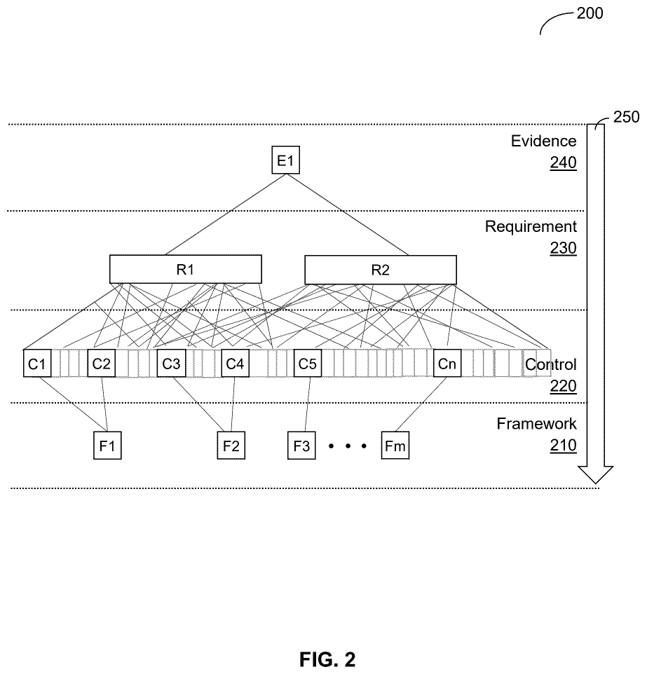

FIG. 2 is an example flow diagram 200 illustrating a mapping of an evidence to a plurality of frameworks via a multi-layer data architecture according to an embodiment. For simplicity and without limitation of the disclosed embodiments, FIG. 2 will also be discussed with reference to the elements shown in FIG. 1.

The multi-layer data architecture (also simply referred to as a multi-layer architecture) including, without limitation, a framework layer 210, a control layer 220, and a requirement layer 230, may be stored in one or more datastores such as the frameworks datastore 121, the requirement datastore 122, or both. In an example embodiment, the frameworks datastore 121 includes a framework data including information on a plurality of compliance frameworks and a plurality of controls for each of the frameworks in the plurality of frameworks. The framework data is organized as the framework layer 210 and the control layer 220.

In an embodiment, the multi-layer data architecture has a framework layer 210, a control layer 220, and a requirement layer 230. As described above, the framework layer 210 includes a plurality of compliance frameworks from F1 through Fm (wherein “m” is an integer greater than 1), each representing a different compliance framework. A tenant entity may select a subset of the plurality of frameworks F1 through Fm for compliance monitoring. The control layer 220 has a plurality of controls C1 through Cn (wherein “n” is an integer greater than 1) that are associated with at least one framework of the framework layer 210. In the example flow diagram 200, the unlabeled boxes between the labeled controls C1 through Cn also indicate controls in the control layer 220. Each framework may have over 5000 controls associated with the framework.

The requirement layer 230 includes a plurality of requirement data that are generated to represent criteria for the plurality of controls. In an embodiment, the requirement layer 230 is a centralized layer that includes unified required data (and terminology) that is independent from the frameworks. The requirement is not tied to a specific framework and the requirement data may be shared amongst controls of various frameworks. In an embodiment, similar controls with common criteria may share a common requirement.

In the example flow diagram 200, an evidence E1 is retrieved and included in the evidence layer 240. The compliance testing of the evidence E1 against the plurality of frameworks is executed by utilizing data in the evidence layer 240 to the framework layer 210 in the direction 250. The evidence data E1 is matched to one or more requirements R1 and R2 of the requirement layer 230. The matching indicates that the evidence data E1 fulfills both requirements R1 and R2. The requirements R1 and R2 are each mapped to multiple controls, controls from C1 through Cn, of different frameworks. Requirement R1 may be cross mapped to all controls, regardless of their framework, for which R1 is a requisite of the control. Similarly, requirement R2 may be cross mapped to all controls independent from the associated framework. In some embodiments, mapping of the evidences to one or more requirements may be predetermined and stored. As an example, each requirement may be associated with a list of evidences that may be obtained from various plugins in the tenant system.

The mapped controls (e.g., C1, C2, etc.) in the control layer 220 are utilized to identify at least one framework F1 through Fm that is associated with the mapped controls. In the example flow diagram 200, the mapped controls C1 and C2 are controls of a framework F1 and thus utilized to determine the compliance score or status of the framework F1.

As shown in the example flow diagram 200, the requirements R1 and R2 may be simultaneously mapped to multiple controls such as C1, C2, C4, C5, and more. The simultaneous cross mapping of the requirements to the controls enables compliance monitoring for all the plurality of frameworks in the framework layer 210 based on the retrieved evidence E1. That is, the effect of E1 on the compliance state (or posture) with respect to the frameworks is concurrently determined, whether a change in posture occurs or not. It should be noted that the example flow diagram 200 illustrates cross mapping and compliance analysis based on a single evidence E1. In an embodiment, large amounts of evidences are collected for various systems or plugins (e.g., service, application, etc.) of the tenant infrastructure.

As an example, requirement R1 is enforcing a multifactor authentication, and requirement R2 is a password policy configuration that is identified in the evidence data E1. Both requirements R1 and R2 are associated with a control for secure configuration. However, depending on the specific control criteria, R1 and R2 may be mapped to the same control or different controls. A first control C3 may require both R1 and R2, and a second control C5 may only require R2 without the multifactor authentication of R1. In the same example, a compliance posture for each framework F2 and framework F3 is determined based on the mapping.

It should be noted that even if the controls are policies that are aimed at avoiding an identical risk, ‘secure authentication’ for example, the specific requirements for the controls may differ. To this end, directly equating control-to-control is an inaccurate determination of compliance. According to the disclosed embodiments, the cross mapping of the universal requirements allows identification based on specific criteria of the controls rather than based on the general aim of the control, thereby improving accuracy and efficiency.

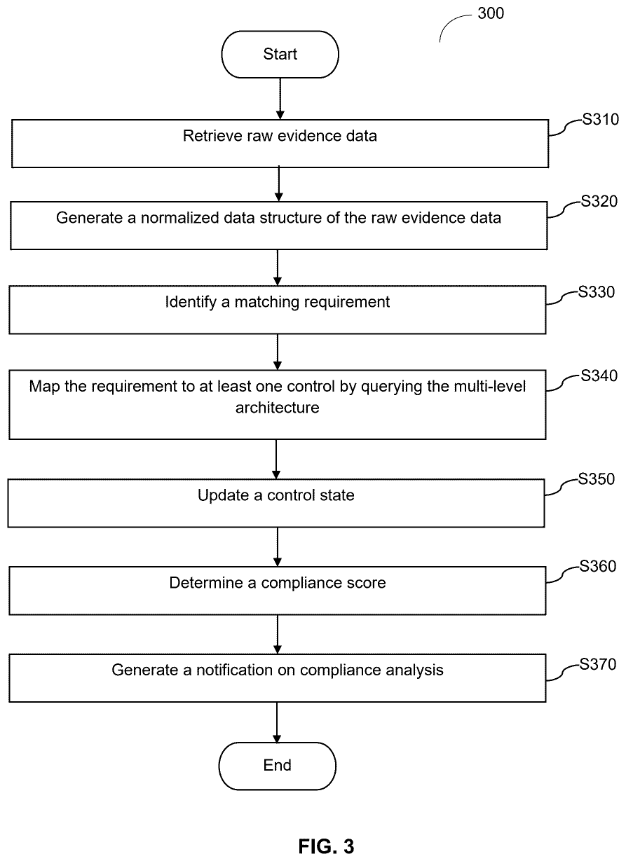

FIG. 3 is an example flowchart 300 illustrating a method of cross mapping an evidence to a plurality of frameworks according to an embodiment. The method described herein is performed in the evidence system 130, FIG. 1.

The method describes the mapping of one evidence data in a single tenant for simplicity purpose. However, it should be noted that this approach may be applied to, for example, hundreds, or even thousands of evidence data for each tenant entity. In an embodiment, the method is performed per tenant, per plugin, and/or per account in order to effectively map evidence data to requisite controls while maintaining data security through segregation. It should be noted that evidence collected from tenants is prevented from sharing computer memory and/or resources at the same instance for added data security.

At S310, raw evidence data are retrieved. The raw data on the evidence of compliance (or simply referred to as evidence or evidence artifact herein) are retrieved from an evidence datastore (e.g., the evidence datastore 123, FIG. 1). In an example embodiment, the raw evidence data are retrieved at predetermined time intervals. In another example embodiment, the raw evidence data are retrieved upon triggered collection of the raw evidence data from the tenant system (or infrastructure). The trigger for collection may be activated at predetermined time intervals, a predetermined schedule, on-demand requests, and the like, and any combination thereof. A query and access to the evidences are submitted via an API at the tenant system. The query, access, and collection of evidences are securely performed by implementing, for example, but not limited to, a secure tunnel, authorization credentials, authentication, individual instances, and the like, and any combination thereof.

An evidence artifact is data and/or documents collected from the tenant system may be used for demonstrating compliance with framework controls, within an overarching control framework. Some examples of evidence may include, but are not limited to, policies, standard operation procedures, audit log samples, authentication configurations, technical system configurations, change management mechanism, and the like, and any combination thereof. The raw evidence data is collected with metadata such as, but not limited to, datetime stamps, API requests performed, item counts, a one-way hash, tenant name or identifier (ID), user system ID, and the like, and any combination thereof. The raw evidence data content is fields collected from a tenant system via an API endpoint without additional manipulation.

In an embodiment, the raw evidence data may be retrieved from, for example, a single account or multiple accounts. Where multiple accounts are to be linked to a single control, and in turn a single compliance analysis, each account run on a separate instance for analysis of the raw data. As such, a raw data evidence is preserved per source account, and per collection. To this end, such separation allows for a compliance status to be derived per collection (compliance over predefined time period), as well as per account as to attest to account-based compliance, as well as overall compliance status per control.

At S320, a normalized data structure is generated. The raw evidence data such as, but not limited to, screenshots, texts, images, JavaScript Object Notation (JSON) files with varying structures, and the like, and any combination thereof are reorganized into normalized data structures. In an embodiment, the normalized data structure is a table-form data structure that includes data fields for controls and their criteria as data elements. In an embodiment, the data elements indicating certain criteria are extracted from the received raw evidence data for the data structure. The normalized data structure for the raw evidence data may be stored in a memory and/or datastore (e.g., the evidence datastore 123, FIG. 1.).

The normalized data structure organizes the controls and their criteria so that the evidence data may be rapidly analyzed against the plurality of compliance frameworks. Such analysis is performed based on one or more data elements identified in the normalized data structure. In an embodiment, the table-form data structure may be easily filtered and queried to enable the derivation of insights. The insights may include, for example, but are not limited to, the detection of non-compliance with organizational policies, controls, or simply misconfigurations. It should be further noted that the normalized data structure facilitates filtering of the data structure to allow instantaneous testing of evidence artifacts against defined control objectives. As an example, an auditor may filter the table based on their auditing objectives for compliance analysis with improved efficiency.

At S330, a matching requirement is identified. The matching requirement is a requirement data in the requirement layer of the multi-layer data architecture that matches the data element in the normalized evidence data structure. The match suggests that the retrieved evidence satisfies and/or supports the requirement or universal criteria. In an embodiment, the requirement data may include a predetermined list of expected evidence data for matching against the data element of the evidence data structure in order to determine the matching requirement. The requirement layer including the plurality of requirements is employed to determine the matching requirement. It should be noted that the requirements are unified terminology and data that may be utilized universally across various frameworks. The requirement layer (or requirement library) is retrieved from a datastore (e.g., the requirement datastore 122, FIG. 1).

At S340, the identified matching requirement is mapped to at least one control of the plurality of frameworks. A multi-layer data architecture, particularly the requirement layer that describes the requirement-control relationship is employed and queried. The controls that are mapped in connection to the matching requirement in the multi-layer data architecture are identified. Such mapped controls, which may belong to different frameworks, commonly share the matching requirement as a criterion for control fulfillment. It should be noted that the universal requirement data allows the matching requirement to be cross mapped to multiple controls across different frameworks.

It should be further noted that the cross mapping of the requirement, which represents the evidence element, initiates simultaneous compliance monitoring for the plurality of frameworks. In an embodiment, the matching requirement may be mapped with a portion of the criteria of the control. The control may include one or more requirements to be completely fulfilled. The matching of requirements to the control objectives (or criteria) provides a more granular analysis of compliance and reduces false positive (i.e., false security). As an example, two controls with the same title, but unique criteria, are not mapped to identical criteria. Instead, each of the controls are mapped to requirements that match the unique criteria. That is, the two controls may be mapped to different sets of requirements based on the minor differences (or nuances) in their specific criteria. It should be noted that traditional control-to-control mapping does not account for the nuances and/or intricacies of similar controls across different control frameworks.

At S350, a control state is updated for relevant frameworks of the plurality of frameworks. The control state indicates whether the control for the framework is fulfilled or not (e.g., success or failure). In an embodiment, the control state may be partially updated when portions of the control criteria are mapped with the matching requirement and thus fulfilled. For example, fulfillment of a specific control criterion is incrementally updated as it is fulfilled without reserving update until all criteria of the control are fulfilled. In a further embodiment, the control state of the controls that are not mapped may remain unchanged. The updating of the control state may further include adding the matched data element of the evidence data structure to the mapped control data. It should be noted that the evidence is analyzed against the plurality of controls and the plurality of frameworks using common matched requirements to determine and monitor control state changes in those plurality of frameworks.

At S360, a compliance score is determined. The compliance score, for example, is a numerical value indicating a degree of compliance of the tenant to the framework based on the collected and analyzed evidences. In an embodiment, the compliance score is determined for each of the plurality of frameworks to indicate an overall compliance of the tenant entity with respect to each of the frameworks. In an embodiment, the updated control states of the relevant frameworks are utilized to determine the compliance score. In an example embodiment, the compliance score is a percentage of satisfied requirements over a total number of requirements in a respective framework. In another example embodiment, the compliance score is determined according to a plurality of rules defined by weights, ranks, and the like, applied to the control states in the framework. In an embodiment, the determined control states and compliance scores may be stored with respect to the control and/or the framework in a memory and/or a datastore (e.g., the requirement datastore 122, the evidence datastore 123, and the like).

In a further embodiment, the compliance score may be determined for a subset of the plurality of frameworks depending on a filtering rule. The filtering rule may include, for example, but is not limited to weights, scores, and the like, and any combination thereof to filter irrelevant frameworks based on, for example, but not limited to, geographical location, industry, at least one metadata, and the like, and any combination thereof. In a further example embodiment, the subset of the plurality of frameworks may be defined as a preference by the tenant entity. For example, the tenant entity may set a rule to select certain frameworks of their concern, thereby limiting the compliance analysis to the frameworks in the subset of the plurality of frameworks. It should be noted that such a subset selected by the rule prevents unnecessary processing and load to determine the compliance score for all frameworks in the plurality of frameworks.

At S370, a notification is generated and caused to be displayed via a user device. The notification describes the tenant entity's compliance with the plurality of frameworks and may include, for example, but not limited to, the plurality of frameworks, the respective compliance scores, a list of controls and their fulfillment for each framework, and the like, and any combination thereof. The notification is generated and available via the user device (e.g., the user device 140, FIG. 1) of the tenant entity. The notification may be, for example, but not limited to, a report, an alert, or the like. The generation of the notification is triggered based on the compliance analysis with respect to the received evidence data. In an embodiment, the notification may be generated at, for example, but not limited to, scheduled times, regular intervals, on demand, and the like, and any combination thereof. In a further embodiment, the notification may be generated upon detection of, for example, but not limited to, a change in compliance score, a compliance score above predetermined threshold values, and the like for at least one framework of the plurality of frameworks.

In some implementations, the notification may be displayed as part of a graphical user interface (GUI) that a tenant operator may interact with via the user device. The GUI may be a dashboard including features of the notifications as well as other information such as, but not limited to, requirements (matched or not matched) for each control, expected evidences for each requirement for the potential plugins (e.g., application, service, etc.) at the tenant system, and the like, and any combination thereof. It should be noted that the notification may be generated at a sufficiently fast rate, at near real-time or real-time, upon retrieval of the evidence data by employing the cross mapping method described in FIG. 3.

Siloed processing of evidence data against a framework can be challenging to obtain at a rate near real-time. Moreover, multiple siloed processing for each framework of the plurality of frameworks can create a large overhead and take a longer period of time due to the amount of processing to be performed, in account for the plurality of frameworks and each retrieved evidence. It should be noted that the embodiments described herein allow simultaneous analysis and generation of a notification for the evidence data against the plurality of controls and their respective plurality of frameworks. The simultaneous processing significantly reduces the amount of data processing and time, thereby conserving computational resources for tracking the compliance. It should be further noted that such efficient tracking allows up-to-date compliance and risk assessments for improved security at the organization.

In a further embodiment, the generated notification may include suggestions to mitigate risks or violations based on the determined control states and/or compliance scores. In an example embodiment, a failed control state may be used to identify the control that violates the framework security, as well as its specific requirements for update. In some implementations, the expected evidences for such specific requirements may be identified and provided to guide the tenant entity (and its user) to actively perform a mitigation action. The mitigation action may include, for example, but not limited to, providing evidence data, changing policy for plugin and/or tenant system, adding requirement measures, changing the configuration of the organization infrastructure or security structure, and the like, and any combination thereof to satisfy the requirement, associated control, and in return the compliance framework. It should be noted that a failure to satisfy the requirement or its control may cause a breach of security in the tenant system.

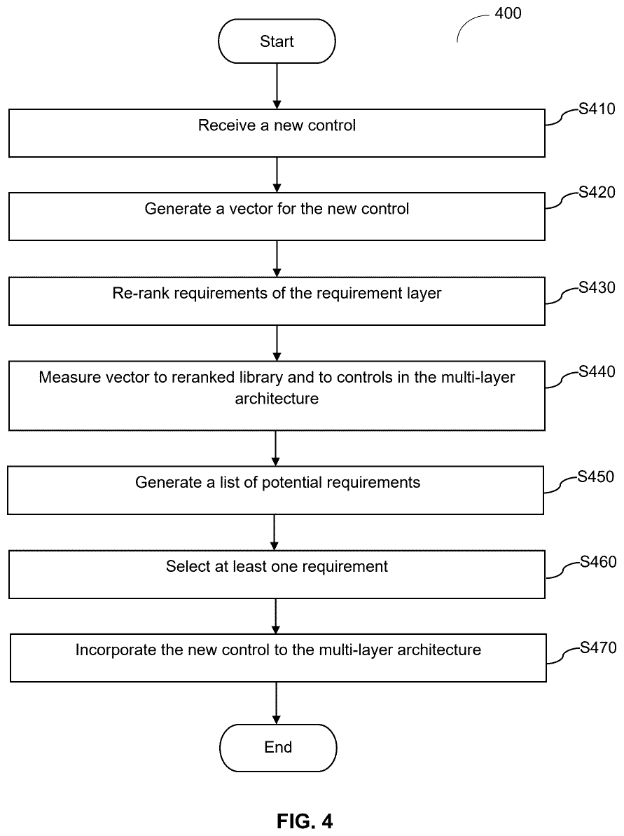

FIG. 4 is an example flowchart 400 illustrating a method for adding a new control to a multi-layer data architecture according to an embodiment. The method is performed in the evidence system 130 and the multi-layer data architecture, initial and updated, may be stored in the frameworks datastore 121 and/or the requirement datastore 122, FIG. 1. In an embodiment, at least one algorithm such as a machine learning algorithm, or an artificial intelligence (AI) algorithm is applied to determine unified requirements for the new control.

At S410, a new control is received. The new control data may include, for example, but not limited to, the new control name, control category, description, associated framework and the like, and any combination thereof. The new control data may be received over a network from a user device (e.g., the user device 140, FIG. 1), a datastore (e.g., the frameworks datastore 121, FIG. 1), an external entity associated with a compliance framework, and the like, and any combination thereof via, for example and without limitation, a graphical user interface (GUI) and/or an API endpoint. In an example embodiment, the new controls may be received in bulk through bulk uploading, as part of a custom control framework.

In some implementations, a new framework having at least one control may be received. A plurality of controls may be identified by, for example, but not limited to, the received framework data, extracting the controls data from the received new framework data, and the like, and any combination thereof.

At S420, a control vector is generated for the received new control. In an embodiment, vector embeddings are generated on the new control that includes, for example, name, category, description, and the like, and any combination thereof. The vector embedding numerically represents the meaning of the new control data (e.g., the description) and is utilized for processing.

At S430, requirements in a requirement layer are reranked. The requirements that are reranked may include all possible requirements in the requirement layer. In an embodiment, the requirements are reranked based on their linguistic similarity to the new control data. A requirement library that includes the reranked requirement is referred to as a reranked library. In an example embodiment, the reranking is performed to determine the top-ranked requirements, for example above a predetermined rank, that are linguistically (by meaning) similar to the new control. In an example embodiment, the predetermined rank is 30, thereby determining the top 30 requirements that are related to the new control. Some example techniques for determining linguistic similarity may include, without limitation, word embeddings, sentence embeddings, knowledge graph-based similarity, Wu-Palmer similarity, Leacock-Chodorow similarity, distance proximity, transformer models (e.g., BERT (Bidirectional Encoder Representations from Transformers), ROBERTa (Robustly Optimized BERT Pretraining Approach), GPT (Generative Pretrained Transformer), and more), fine-tuned transformer models, and the like, and any combination thereof. In an embodiment, an artificial intelligence (AI)-based reranking model may be applied to the requirements.

At S440, the control vector is measured with respect to the reranked library of requirements and to controls in the multi-layer architecture. The vector measurement may be a vector proximity in the embedding space. The proximity is based on similarity metrics (e.g., cosine similarity, etc.), distance metrics (e.g., Euclidean distance, Manhattan distance, Jaccard distance, Hamming distance, etc.), and the like, and more. In an embodiment, the control vector is measured against each requirement vector in the reranked library to determine the proximity.

In a further embodiment, the control vector is measured against vectors of existing controls in the multi-layer architecture in order to determine similar existing controls. The similar existing controls are previously incorporated controls in the multi-layer architecture that are in vector proximity to the new control vector. An existing control in the multi-layer architecture is mapped to at least one requirement in the requirement layer as described in FIG. 2. The multi-layer architecture represents established relationships between the requirements and the controls based on previously detected and analyzed historical data. For example, the multi-layer architecture includes thousands of existing controls that are each mapped to one or more requirements in the requirement layer. Such mappings are considered as true or verified relationships. By leveraging the control-to-requirement mapping in the multi-layer architecture, the at least one requirement of the similar existing control is identified to also be a related requirement for the new control. Here, the related requirements of the new control may also be mapped to the existing controls that are identified to be in close proximity to the new control.

At S450, a list of potential requirements for the new control is generated. The potential requirements are identified from the reranked library based on the vector measurements of the new control vector against the reranked requirements. In addition, the potential requirements are the related requirements identified based on the vector measurements against requirements in the existing multi-layer architecture. In an embodiment, a greater weight is given to the related requirements, for example over the selected reranked requirements, when generating and ranking the potential requirements in the list. In an example embodiment, the requirements are ranked from greatest proximity to lowest proximity. It should be noted that the potential requirements in the list are select portions from the vector measurements and comparison of the control vector (S440).

At S460, at least one new requirement for the new control is selected. The at least one new requirement is selected based on a score determined for the potential requirements in the list of potential requirements. The score may be generated based on the vector measurement between the potential requirement and the new control. In an embodiment, one or more requirements in the list with a score above a predetermined threshold score may be selected. As an example, the predetermined threshold score may be 67%. In another example, the predetermined threshold score may be 90%. In some implementations, a first predetermined threshold for selecting the new requirement for incorporation in the multi-layer architecture may be different, and for example higher, than a second predetermined threshold score for causing a display at a user device (e.g., the user device 140, FIG. 1), for example, on a report, or graphical user interface (GUI).

At S470, the new control is incorporated into the multi-layer data architecture. The new control is added in association with the selected new requirements and the corresponding framework. It should be noted that the new control is readily incorporated into the existing multi-layer data architecture without disrupting the previously established network. Thus, scale-out of the multi-layer architecture may be efficiently and effectively performed for conservation of computing resources such as CPU usage, memory space, and the like.

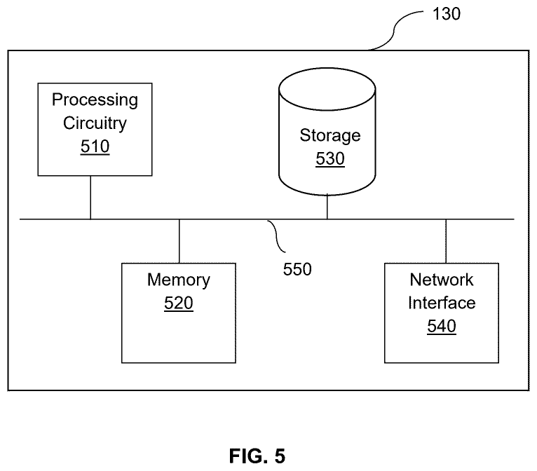

FIG. 5 is an example schematic diagram of an evidence system 130 according to an embodiment. The evidence system 130 includes a processing circuitry 510 coupled to a memory 520, a storage 530, and a network interface 540. In an embodiment, the components of the evidence system 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the evidence system 130 to communicate with other systems, devices, components, applications, or other hardware or software components, for example as described herein.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for cross mapping an evidence data for risk management, comprising:
identifying a matching requirement for a first data element of the evidence data by matching the first data element to a requirement in a centralized requirement layer of a multi-layer data architecture;
mapping the matching requirement to at least one control in more than one framework of a plurality of frameworks according to the multi-layer data architecture, wherein the centralized requirement layer of the multi-layer data architecture has a plurality of requirements that each represent a criterion and are shared across the plurality of frameworks; and
determining, based on the mapping, a control state for the at least one control in more than one framework of the plurality of frameworks in response to the evidence data.

2. The method of claim 1, further comprising:
constructing a normalized data structure for a raw data of the evidence data, wherein the normalized data structure organizes criteria in the raw data as data elements.

3. The method of claim 1, wherein the centralized requirement layer has established relationships between the plurality of requirements and a plurality of controls across the plurality of frameworks.

4. The method of claim 1, wherein the mapping of the matching requirement to at least one control indicates that the first data element defined by the matching requirement fulfills the criterion of the at least one control.

5. The method of claim 1, further comprising:
determining a compliance score for each of the plurality of frameworks, wherein the compliance score represents a degree of overall compliance based on a plurality of controls and their control states for each of the plurality of frameworks.

6. The method of claim 1, further comprising:
generating a notification of compliance with respect to the plurality of frameworks, wherein the notification of compliance indicates a compliance and risk assessments for a tenant; and
causing a display of the notification via a tenant device.

7. The method of claim 6, wherein the notification includes at least one of: a suggestion to mitigate risks, a suggestion to mitigate a violation, a mitigation action, a compliance score, a list of controls, and their control state.

8. The method of claim 1, wherein the mapping is a cross mapping of the evidence data to the plurality of frameworks in near real-time.

9. The method of claim 1, wherein the multi-layer data architecture incorporates a new control by measuring a vector distance between a new criterion in the new control to the plurality of requirements in the centralized requirement layer in the multi-layer data architecture.

10. A non-transitory computer readable medium having stored thereon instructions for causing a processing circuitry to execute a process, the process comprising:
identifying a matching requirement for a first data element of evidence data by matching the first data element to a requirement in a centralized requirement layer of a multi-layer data architecture;
mapping the matching requirement to at least one control in more than one framework of a plurality of frameworks according to the multi-layer data architecture, wherein the centralized requirement layer of the multi-layer data architecture has a plurality of requirements that each represent a criterion and are shared across the plurality of frameworks; and
determining, based on the mapping, a control state for the at least one control in more than one framework of the plurality of frameworks in response to the evidence data.

11. A system for cross mapping an evidence data for risk management, comprising:
a processing circuitry; and
a memory, the memory containing instructions that, when executed by the processing circuitry, configure the system to:
identify a matching requirement for a first data element of the evidence data by matching the first data element to a requirement in a centralized requirement layer of a multi-layer data architecture;
map the matching requirement to at least one control in more than one framework of a plurality of frameworks according to the multi-layer data architecture, wherein the centralized requirement layer of the multi-layer data architecture has a plurality of requirements that each represent a criterion and are shared across the plurality of frameworks; and
determine, based on the mapping, a control state for the at least one control in more than one framework of the plurality of frameworks in response to the evidence data.

12. The system of claim 11, wherein the system is further configured to:
construct a normalized data structure for a raw data of the evidence data, wherein the normalized data structure organizes criteria in the raw data as data elements.

13. The system of claim 11, wherein the centralized requirement layer has established relationships between the plurality of requirements and a plurality of controls across the plurality of frameworks.

14. The system of claim 11, wherein the mapping of the matching requirement to at least one control indicates that the first data element defined by the matching requirement fulfills the criterion of the at least one control.

15. The system of claim 11, wherein the system is further configured to:
determine a compliance score for each of the plurality of frameworks, wherein the compliance score represents a degree of overall compliance based on a plurality of controls and their control states for each of the plurality of frameworks.

16. The system of claim 11, wherein the system is further configured to:
generate a notification of compliance with respect to the plurality of frameworks, wherein the notification of compliance indicates a compliance and risk assessments for a tenant; and
cause a display of the notification via a tenant device.

17. The system of claim 16, wherein the notification includes at least one of: a suggestion to mitigate risks, a suggestion to mitigate a violation, a mitigation action, a compliance score, a list of controls, and their control state.

18. The system of claim 11, wherein the mapping is a cross mapping of the evidence data to the plurality of frameworks in near real-time.

19. The system of claim 11, wherein the multi-layer data architecture incorporates a new control by measuring a vector distance between a new criterion in the new control to the plurality of requirements in the centralized requirement layer in the multi-layer data architecture.
